(19) United States
(12) Patent Application Publication
(10) Pub. No.: US 2006/0180512 A1
(43) Pub. Date: Aug. 17, 2006

(54) Methods and apparatus for sifting material

(76) Inventor: William P. Allen, Phoenix, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/021,008

(22) Filed: Dec. 23, 2004

(51) Int. Cl. B07B 1/49

(52) U.S. Cl. 209/418

(57) ABSTRACT

Methods and apparatus according to various aspects of the present invention comprise a device for sifting. In one embodiment, the sifting device comprises a body and a retainer.

### BACKGROUND OF THE INVENTION

1. Field of the Invention

This invention pertains generally to methods and apparatus relating to sifting material.

2. Description of Related Art

Sifting apparatus find uses in a variety of applications, such as dredging water ways, screening stone, and garbage separation. Ordinary sifting apparatus include holes through which smaller articles may pass but larger articles cannot. Materials deposited into the sifter are sorted by smaller articles and fluids passing through the holes while the larger objects remain, thus allowing the objects to be separated.

While sifters are effective, they can be cumbersome. The sifter may fill with material and need to be emptied to work properly. Alternatively, the sifter may have items within the sifter that need to be emptied before subsequent use. Sifters also need a mechanism for inserting and removing the sifter from the materials to be sifted.

### BRIEF SUMMARY OF THE INVENTION

Methods and apparatus according to various aspects of the present invention comprise a sifting apparatus for separating larger objects from smaller objects. In one embodiment, the sifting device comprises a body and a retainer to prevent larger objects from exiting the body.

### BRIEF DESCRIPTION OF THE DRAWINGS

A more complete understanding of the present invention may be derived by referring to the detailed description and claims when considered in connection with the figures, wherein like reference numbers refer to similar elements throughout the figures, and:

FIG. 1 is a diagram of a side view of an exemplary sifting apparatus.

FIG. 2 is a diagram of a front view of an exemplary sifting apparatus.

FIG. 3 is a cross-section diagram of the exemplary embodiment of FIG. 2 taken along the line 3-3.

FIG. 4 is a perspective diagram of an exemplary sifting apparatus.

FIG. 5 is a cross-section diagram of the exemplary embodiment of FIG. 2 taken along the line 3-3 with an alternate embodiment of a retainer.

### DETAILED DESCRIPTION OF EXEMPLARY EMBODIMENTS

The accompanying drawings show an exemplary embodiment by way of illustration and best mode. While these exemplary embodiments are described, other embodiments may be realized and mechanical changes may be made without departing from the spirit and scope of the invention. Thus, the detailed description is presented for purposes of illustration only and not of limitation. For example, the steps recited in any of the method or process descriptions may be executed in any suitable order and are not limited to the order presented.

For the sake of brevity, conventional mechanical aspects and components of the individual operating components may not be described in detail. Furthermore, the representations of the various components are intended to represent exemplary functional relationships, positional relationships, and/or physical couplings between the various elements. Many alternative or additional functional relationships, physical relationships, or physical connections may be present in a practical system. The present invention may be embodied as a customization of an existing system or an add-on product.

The present invention is described partly in terms of functional components and various methods. Such functional components may be realized by any number of components configured to perform the specified functions and achieve the various results. For example, the present invention may employ various solid materials, porous materials, mesh materials, permeable materials, perforated materials, net-like materials, connectors, shapes, sizes, connecting methods, and the like, which may carry out a variety of functions. In addition, the present invention may be practiced in conjunction with any number of applications and environments, and the systems described are merely exemplary applications of the invention. Further, the present invention may employ any number of conventional techniques for manufacture, scooping, dredging, emptying, sanitizing, and the like.

Methods and apparatus according to various aspects of the present invention comprise a sifting apparatus configured to enable the user to repeatedly scoop material into the sifting apparatus without emptying the sifted objects from the sifting apparatus after every scoop. Additionally, the sifted objects are substantially retained in the sifting apparatus in such a manner to reduce interference with the process of scooping in and/or sifting additional materials. For example, the sifted objects from previous scoops may be restrained from falling out of the sifting apparatus when the sifting apparatus is positioned to scoop in more materials. The sifting methods and apparatus may be used for any suitable purpose or combination of purposes, such as separating trash, such as cigarette butts, or treasure from sand while prospecting, extracting stones, bulbs, seed pods, etc. from dirt while gardening, extracting solid objects from water, mud or opaque liquids, removing animal feces from a litter box, or any other suitable application. The methods and apparatus may be adapted to any system for separating objects of different sizes for any purpose.

In particular, referring to FIG. 3, a sifting apparatus according to various aspects of the present invention comprises a hollow body 12 having a body opening 14 and a retainer 16. The body 12 may be formed of a material having holes. Materials to be sifted may enter the sifting apparatus through the body opening 14. Finer material and objects may pass through the holes of the mesh material of body 12 leaving larger objects 18 in the body 12. Positioning the body 12 to take another scoop of material causes the larger objects 18 to be retained by the retainer 16, so that the larger objects 18 may remain within the body 12 while scooping in additional materials.

The body 12 may be of any material, shape, size, and configuration for a particular application or environment. For example, the body 12 may be formed using a solid frame covered with a mesh material, a mesh material with no frame, and a frame covered with mesh material for part of the body 12 and mesh materials without a frame for other parts of the body 12. The body 12 may use any material suitable for the purpose of sifting, for example, at least one of polycarbonate, polyethylene, polypropylene, polyvinylchloride, aluminum, steel, iron, copper, zinc, brass, stainless steel, metal alloys, composite material, carbon filament, and titanium.

The holes of the material of the body 12 may be formed in any suitable manner, for example, drilling, extruding, punching, chemically etching, welding, brazing, soldering, and cutting. The holes may be of any shape, for example, at least one of circles, ovals, slots, rectangles, squares, and polygons. The holes may be of any size suitable for the type of materials to be separated. The holes may be distributed in any manner suitable for the application, for example, uniformly, clustered, randomly, and along a gradient.

The body 12 may be of any shape, for example, rectangular, square, cylindrical, semi-circular, spherical, and polygonal, and suitably defines an interior. The body 12 may be of any size suitable for the purpose, for example, a size appropriate for manual use, a size appropriate for attaching a handle intended for manual use, a size appropriate to attach to an extension handle, a size appropriate to be operated by multiple people simultaneously, and a size suitable to be operated by power equipment. In the present embodiment for a manual scoop, the body diameter may be about 3 to 10 inches, such as about 4 inches. The body length may be about 3 to 16 inches, such as about 6.4 inches. The body opening 14 may be located at any appropriate location on the body 12, for example one or both of the lateral ends of the cylindrical body, and may be of any suitable size and shape. The size may also be selected to facilitate access to a selected area, such as a litter box or an ashtray. The body opening 14 may be reinforced to provide greater strength, for example, body opening 14 may be lined with solid material.

In an exemplary embodiment, the body 12 is formed of a moderately rigid, metal mesh material without a frame, such as a mesh formed of woven wires. The holes may be substantially square and may be substantially evenly distributed throughout the entire body. The holes may be of a size suitable to allow, for example, litter box litter and/or sand to pass through the holes while capturing, for example, any object the approximate size of pet feces and/or cigarette butts. The body 12 is sized for manual use by a single person and to allow scooping material from a litter box or ashtray.

The body 12 is substantially cylindrical with the body opening 14 positioned at the front end of the cylinder; the rear end of the cylinder may be covered, such as by mesh. The body opening 14 may be slanted backwards from the bottom to the top to provide an appropriate shape for efficient scooping of material and allow the operator to see the progress of the scoop. The body opening 14 is lined with solid material to provide structural strength when scooping and to facilitate receipt of material through the opening.

The retainer 16 is disposed within the interior of the body 12 and tends to retain selected articles within the interior. The retainer 16 may comprise any suitable system for retaining selected objects within the interior, and may be of any size and/or shape suitable for a particular application or environment. The retainer 16 may be made of any material, for example, solid or mesh.

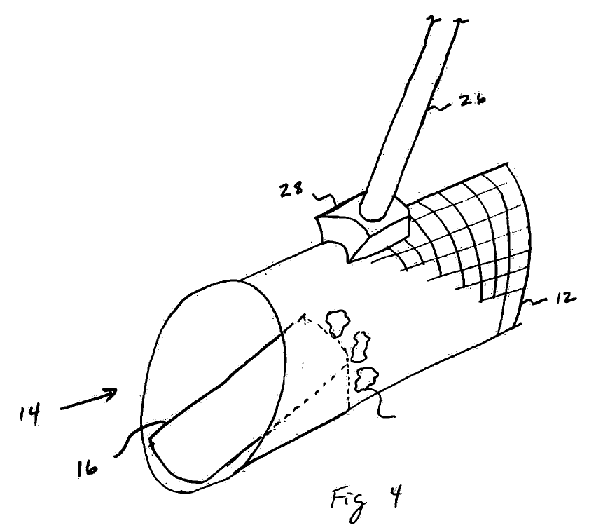

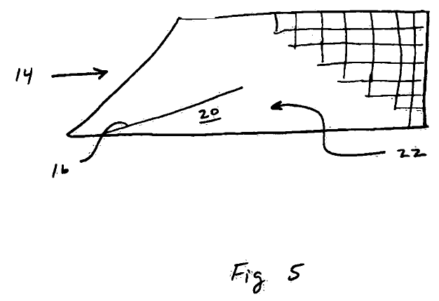

In one embodiment, referring to FIGS. 2-4, the retainer 16 includes a retainer wall 30 and a ramp 32. The retainer wall 30 forms an obstacle between the rear area of the body 12 interior and the body opening 14. The ramp 32 facilitates the passage of material through the body opening 14 and into the body 12 for sifting. The lower end of the ramp 32 is positioned nearest the body opening 14. The finer material exits the body 12 through the holes in the mesh that forms the body 12, leaving the larger objects 18 in the body 12. When the body 12 is tipped forward to scoop in additional material, referring to FIG. 3-4, the retaining wall 30 of the retainer 16 substantially retains larger objects 18 in the body 12. In one embodiment, the retainer 16 is formed of the same mesh material used to form the body 12. The higher end of the ramp 32 may be of any height suitable for a particular application or environment. The height of the ramp 32 may also be adjustable. In the present exemplary embodiment, the inclined surface of the ramp 32 is about 3 to 8 inches long, such as about 4 inches. The height of the retainer wall 30 is adjusted for an incline of about 25-50%, such as about 1.5 inches high for an incline of about 38%.

In anther embodiment, referring to FIG. 5, the retainer 16 is shaped to form a cavity 20. The cavity 20 may be of any size and/or shape suitable for a particular application or environment. The cavity 20 may be inside and/or outside the body 12. The retainer 16 used to form the cavity 20 may be formed using any material, for example, solid and mesh. The retainer 16 may be positioned in such a manner that a part of the body 12 contributes to form cavity 20.

A cavity opening 22 may be wholly or partially inside the body 12. The cavity opening 22 may be wholly or partially blocked at suitable times to enclose the cavity 20 and/or to restrict ingress and egress of materials. Material used to block the cavity opening 22 may be of any type, for example, solid and mesh and may be moved over the cavity opening 22 in any manner such as, for example, manually, automatically, and in response to maintaining the body 12 at a suitable orientation.

In one embodiment, referring to FIG. 2 and FIG. 5, the cavity 20 is formed inside the body 12. The retainer 16 forms the cavity 20 between the retainer 16 and the inside of the body 12. In one embodiment, the retainer 16 may be placed angularly in the body 12, such as to form a ramp. The position of the cavity opening 22 is substantially opposite the body opening 14. When in use, material to be sifted enters the body opening 14, moves past the retainer 16 and into the body 12 where it may be sifted. Finer materials pass through the body 12 while larger objects 18 remain in the body 12. Positioning the body 12 to take another scoop of material causes the larger objects 18 in the body 12 to pass through the cavity opening 22 and to be retained in the cavity 20, so that the larger objects 18 remain substantially within the body 12 while scooping additional material in through the body opening 14.

The body 12 may be grasped, manipulated, and/or positioned in any manner suitable for a particular application or environment. The body 12 may have a particular shape and/or size suited for manual grasping, manipulating, and/or positioning. Referring to FIG. 4, a bracket 28 or other connector may be attached to the body 12 to enable the body 12 to be positioned using any mechanism that may interface with the bracket 28. In one embodiment, a pole 26 and/or an extensible handle connects to the bracket 28. Multiple brackets 28 may interface with the body 12 to allow multiple simultaneous connections and/or separate, sequential connections to individual brackets. Connections between a mechanism and the body 12 may also be magnetic. Any suitable user may grasp, manipulate, and/or position the body 12, for example, at least one human using a manual grasp, at least one human using a manual grasp to a mechanism interfacing with the body 12, a machine controlled by at least one human, a machine controlled by software, a machine that uses hydraulic methods to grasp and/or manipulate the body 12, and any other suitable user.

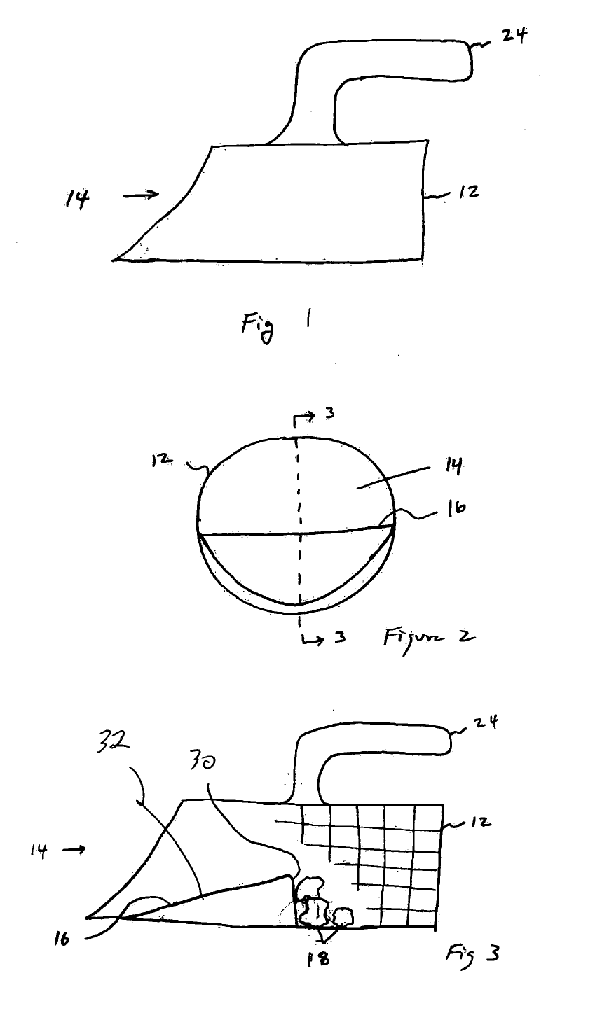

In an exemplary embodiment, referring to FIG. 1, a handle 24, suitable for human manual grasping, manipulating, and/or positioning, may interface with the body 12. The handle 24 may interface with any part of the body 12 and may be shaped in any form to enhance grasping, manipulating, positioning, and/or scooping. In an exemplary embodiment, referring to FIG. 1, and FIG. 3-4, the handle 24 is positioned on the body 12 opposite the retainer 16 and oriented such that positioning the body 12 to scoop in additional material cases the larger objects 18 to be substantially retained by the retainer 16 and substantially remain in the body 12 while scooping.

Sifting materials may be performed in any manner, using any suitable sifting apparatus, body 12, and retainer 16. In an exemplary embodiment, sifting material to separate larger objects 18 from finer material comprises scooping material in to the body 12, agitating the body 12 to facilitate the separation of larger objects 18 from finer materials and to facilitate the egress of finer materials from the body 12, positioning the retained objects rearward of the retainer 16, positioning the sifting apparatus to scoop in more materials, and repeating the scooping, agitating, and positioning steps until the material has been sifted and/or until the retainer cannot retain additional larger objects. A method for removing the larger objects 18 from the body 12 comprises positioning the body 12 such that the larger objects 18 are no longer retained by the retainer 16 and positioning the body 12 such that the larger objects 18 exit the body opening 14.

Scooping materials into the body 12 may be done in any manner. In an exemplary embodiment, referring to FIG. 2-4, the sifting apparatus is tipped forward and pushed through the material to be sifted such that materials enter the body opening 14 and move over and past the retainer 16 into the body 12. During the scooping process, retained objects 18 from previous scoops are substantially retained by retainer 16 and may not exit the body opening 14. Finer materials may pass through the body 12 at any time and from any location where holes are located in the body 12.

Agitating the body 12 may be performed in any manner. The force of agitation may be provided, for example, manually, mechanically, and sonically. Agitation may begin at any point in the scooping process and may continue into the positioning process. In an exemplary embodiment, the body 12 is tipped backward after scooping such that materials are less likely to exit the body opening 14 during the agitation process. During agitation, finer materials are separated from the larger objects 18. Finer materials pass through the holes in the body 12. Larger objects, due to their size, do not pass through the holes in body 12. The agitation process may continue for any duration. Agitation may cause the separation of all or only a fraction of the larger objects 18 and finer materials. In an exemplary embodiment, agitation removes a substantial portion of the finer materials that were scooped in.

The positioning step to scoop in additional material may be performed in any manner. A sifting apparatus that may have a mechanism for covering the cavity opening 22 to retain larger objects in the cavity 20 during the scooping process may be positioned in any position. In an exemplary embodiment, the body 12 is positioned, in preparation to scoop in additional material, in a manner such that the larger objects 18 may be retained inside the body. Any force may be used to retain the larger objects 18 inside the body 12. In an exemplary embodiment, the body 12 is positioned such that gravity substantially influences the larger objects to be retained by the retainer 16 while performing the scooping process. In an alternate embodiment, the body 12 is positioned such that gravity substantially influences the larger objects 18 to enter the cavity opening 22 and to substantially remain in the cavity 20 during the scooping process.

During the sifting process, it may be desirable at various times to remove larger objects 18 from the body 12. The process for removing larger objects 18 from the body comprises forcing the larger objects 18 away from the retainer 16 and forcing the larger objects 18 from the body opening 14. Any method or force, such as gravity, agitation, compressed air, and hydraulic pressure, may be used to remove the larger objects 18 away from the retainer 16 and from the body 12. In an exemplary embodiment, the body 12 may be positioned, for example tipped backwards, such that gravity substantially influences the larger objects 18 away from retainer 16. The body may then be positioned such that the larger objects 18 exit the body opening 14, such as by turning the body laterally and lowering the body opening 14, allowing the retained objects 18 to move past the retainer 16 and out the body opening 14. In an alternate embodiment, the body 12 may be positioned such that gravity substantially influences the larger objects 18 to exit the cavity 20 through the cavity opening 22 into the body 12. The body may then be positioned such that the larger objects 18 exit the body opening 14. The body 12 may also be positioned such that the larger objects 18 are influenced by gravity to not reenter the cavity opening 20, but to exit the body 12 by way of the body opening 14.

Although the description above contains many details, these should not be construed as limiting the scope of the invention but as merely providing illustrations of some of the exemplary embodiments of this invention. The scope of the present invention fully encompasses other embodiments, and is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments are expressly incorporated by reference and are intended, unless otherwise specified, to be encompassed by the claims.

Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims. No claim element is to be construed under the provisions of 35 U.S.C. 112, sixth paragraph, unless the element is expressly recited using the phrase “means for.” The terms “comprises”, “comprising”, or any other variation, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A sifting device, comprising:
a body, comprising a surface having a plurality of holes and defining:
an interior; and
a body opening providing access to the interior; and
a retainer disposed within the interior and configured to retain articles within the interior.

2. A sifting device according to claim 1, wherein the retainer comprises a retaining wall disposed across a bottom surface of the interior and forms an obstacle between a portion of the interior and the body opening.

3. A sifting device according to claim 1, wherein the retainer comprises a retainer surface defining a cavity within the interior and forms an obstacle between a portion of the interior and the body opening.

4. A sifting device according to claim 3, wherein the retainer surface defines a cavity opening between the cavity and the interior, and wherein the cavity opening is located at an end of the cavity opposite the body opening.

5. A sifting device according to claim 1, further comprising a ramp between the body opening and the retainer.

6. A sifting device according to claim 1, wherein the body opening is slanted towards a rear portion of the body from a bottom of the body to a top of the body.

7. A sifting device according to claim 1, wherein the retainer comprises means for forming an obstacle between a portion of the interior and the body opening.

8. A sifting device according to claim 1, wherein the body comprises a mesh material.

9. A sifting device according to claim 1, wherein the retainer comprises a mesh material.

10. A sifting device according to claim 1, wherein the holes are sized to block passage of pet feces.

11. A sifting device, comprising:
a body having an interior chamber, including:
a perforated bottom surface; and
an opening surface defining a lateral body opening in the body providing access to the interior; and
retaining means for retaining objects within a portion of the interior chamber.

12. A sifting device according to claim 11, wherein the retaining means comprises a retaining wall disposed across the bottom surface, wherein the retaining wall forms an obstacle between the portion of the interior chamber and the body opening.

13. A sifting device according to claim 11, wherein the retaining means comprises a retainer surface defining a cavity within the interior chamber, wherein the retainer surface forms an obstacle between the portion of the interior chamber and the body opening.

14. A sifting device according to claim 13, wherein the retainer surface defines a cavity opening between the cavity and the interior chamber, and wherein the cavity opening is located at an end of the cavity opposite the body opening.

15. A sifting device according to claim 11, further comprising a ramp between the body opening and the retaining means.

16. A sifting device according to claim 11, wherein the body opening is slanted towards a rear portion of the body from a bottom of the body to a top of the body.

17. A sifting device according to claim 11, wherein the retaining means comprises means for forming an obstacle between a portion of the interior and the body opening.

18. A sifting device according to claim 11, wherein the body comprises a mesh material.

19. A sifting device according to claim 11, wherein the retaining means comprises a mesh material.

20. A sifting device according to claim 11, wherein multiple perforations formed in the perforated bottom surface are sized to block passage of pet feces.

21. A sifting device, comprising:
a body comprising a mesh material and defining:
an interior; and
a body opening at a lateral end of the body; and
a retainer wall disposed across a surface bottom of the interior, wherein the retainer wall forms an obstacle between a portion of the interior and the body opening.

22. A sifting device according to claim 21, wherein the retainer wall comprises a retainer surface defining a cavity within the interior.

23. A sifting device according to claim 22, wherein the retainer surface defines a cavity opening between the cavity and the interior, and wherein the cavity opening is located at an end of the cavity opposite the body opening.

24. A sifting device according to claim 21, further comprising a ramp between the body opening and the retainer wall.

25. A sifting device according to claim 21, wherein the body opening is slanted towards a rear portion of the body from a bottom of the body to a top of the body.

26. A sifting device according to claim 21, wherein the retainer comprises the mesh material.

27. A sifting device according to claim 21, wherein the mesh material includes holes sized to block passage of pet feces.
